(19) United States
(12) Patent Application Publication
(10) Pub. No.: US 2008/0181667 A1
(43) Pub. Date: Jul. 31, 2008

(54) Line Head and An Image Forming Apparatus Using the Line Head

(75) Inventors: Yujiro NOMURA, Shiojiri-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/970,463

(22) Filed: Jan. 7, 2008

(30) Foreign Application Priority Data
Jan. 19, 2007 (JP) 2007-010386

(51) Int. Cl. G03G 15/04

(52) U.S. Cl. 399/218

(57) ABSTRACT

A line head, includes: a lens array in which a plurality of imaging lenses whose absolute value of magnification is m are arranged in a longitudinal direction which corresponds to a main scanning direction for a surface-to-be-scanned; and a plurality of luminous element groups which are disposed in one-to-one correspondence to the plurality of imaging lenses, wherein in each one of the plurality of luminous element groups, the plurality of luminous elements are arranged at mutually different positions in the longitudinal direction spaced apart by an element pitch dp, the plurality of luminous elements of this luminous element group are respectively turned on to emit light beams at timings in conformity with a movement of the surface-to-be-scanned in a sub scanning direction, the light beams emitted from the plurality of luminous elements of this luminous element group are imaged on the surface-to-be-scanned at mutually different positions in the main scanning direction, and accordingly a plurality of spots are formed side by side in the main scanning direction, thereby forming a spot group, and the following inequality is satisfied: L·m>P−m·dp where the symbol P denotes a distance between optical axes of the imaging lenses adjacent to each other in the longitudinal direction and the symbol L denotes an inter-element distance in the longitudinal direction between two luminous elements which are farthest from each other in each luminous element group.

### CROSS REFERENCE TO RELATED APPLICATION

The disclosure of Japanese Patent Application No. 2007-010386 filed on Jan. 19, 2007 including specification, drawings and claims is incorporated herein by reference in its entirety.

### BACKGROUND

1. Technical Field

The present invention relates to a line head which scans a light beam across a surface-to-be-scanned and an image forming apparatus using the line head.

2. Related Art

A line head using a luminous element array, for example, as disclosed in JP-A-2000-158705 has been proposed as a line head of this type, the luminous element array being constructed with a plurality of luminous elements linearly arrayed at constant pitches in the longitudinal direction corresponding to a main scanning direction. In such a line head, a plurality of luminous element arrays are provided and lenses are arranged in one-to-one correspondence with the respective luminous element arrays. In each luminous element array, light beams are emitted from the plurality of luminous elements belonging to this array, and the emitted light beams are focused on a surface-to-be-scanned by the lens arranged in conformity with this array. In this way, spots are formed in a line in the main scanning direction on the surface-to-be-scanned.

### SUMMARY

By the way, a group of spots are formed on the surface-to-be-scanned by the plurality of luminous elements of each luminous element array, thereby forming a spot group. In this spot group, the relative positional relationship of the spots is constant. However, since the plurality of luminous element arrays are arrayed in the longitudinal direction in the line head of JP-A-2000-158705, there have been cases where the positions of the luminous elements are displaced on an array basis. Upon the occurrence of such displacements, spot positions are relatively displaced among the spot groups, whereby clearances are formed between the spot groups. Particularly in an image forming apparatus for forming a latent image on a photosensitive member using a line head having such a problem and forming a toner image by developing the latent image, image quality is reduced due to vertical lines appearing in the toner image. Since the respective lenses are not integrally constructed in the line head of JP-A-2000-158705, relative position errors of the respective lenses are large. Thus, there have been cases where the spot positions on the surface-to-be-scanned are displaced among the respective spot groups and a problem similar to the above occurs. A similar problem occurs also when there are magnification errors of the lenses.

An advantage of some aspects of the invention is to provide a technique capable of realizing satisfactory spot formation in a line head and an image forming apparatus using a plurality of luminous elements.

According to a first aspect of the invention, there is provided a line head, comprising: a lens array in which a plurality of imaging lenses whose absolute value of magnification is m are arranged in a longitudinal direction which corresponds to a main scanning direction for a surface-to-be-scanned; and a plurality of luminous element groups which are disposed in one-to-one correspondence to the plurality of imaging lenses, wherein in each one of the plurality of luminous element groups, the plurality of luminous elements are arranged at mutually different positions in the longitudinal direction spaced apart by an element pitch dp, the plurality of luminous elements of this luminous element group are respectively turned on to emit light beams at timings in conformity with a movement of the surface-to-be-scanned in a sub scanning direction, the light beams emitted from the plurality of luminous elements of this luminous element group are imaged on the surface-to-be-scanned at mutually different positions in the main scanning direction, and accordingly a plurality of spots are formed side by side in the main scanning direction, thereby forming a spot group, and the following inequality is satisfied: L·m>P−m·dp where the symbol P denotes a distance between optical axes of the imaging lenses adjacent to each other in the longitudinal direction and the symbol L denotes an inter-element distance in the longitudinal direction between two luminous elements which are farthest from each other in each luminous element group.

According to a second aspect of the invention, there is provided an image forming apparatus, comprising: a latent image carrier whose surface is transported in a sub scanning direction; a line head which images a plurality of spots on a surface of the latent image carrier in a main scanning direction which is approximately orthogonal to the sub scanning direction to form a latent image; and a developer which develops the latent image on the latent image carrier with toner, wherein the line head comprises: a lens array in which a plurality of imaging lenses whose absolute value of magnification is m are arranged in a longitudinal direction which corresponds to the main scanning direction; and a plurality of luminous element groups which are disposed in one-to-one correspondence to the plurality of imaging lenses, wherein in each one of the plurality of luminous element groups, the plurality of luminous elements are arranged at mutually different positions in the longitudinal direction spaced apart by an element pitch dp, the plurality of luminous elements of this luminous element group are respectively turned on to emit light beams at timings in conformity with a movement of the surface of the latent image carrier in the sub scanning direction, the light beams emitted from the plurality of luminous elements of this luminous element group are imaged on the surface of the latent image carrier at mutually different positions in the main scanning direction, and accordingly a plurality of spots are formed side by side in the main scanning direction, thereby forming a spot group, and the following inequality is satisfied: L·m>P−m·dp where the symbol P denotes a distance between optical axes of the imaging lenses adjacent to each other in the longitudinal direction and the symbol L denotes an inter-element distance in the longitudinal direction between two luminous elements which are farthest from each other in each luminous element group.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a diagram showing an embodiment of an image forming apparatus according to the invention.

FIG. 2 is a diagram showing the electrical construction of the image forming apparatus of FIG. 1.

FIG. 3 is a perspective view schematically showing a first embodiment of the line head according to the invention.

FIG. 4 is a section along width direction of the embodiment of the line head according to the invention.

FIG. 5 is a perspective view schematically showing the microlens array.

FIG. 6 is a longitudinal section of the microlens array.

FIG. 7 is a diagram showing the arrangement relationship of the luminous element groups and the microlenses in the line head.

FIG. 8 is a diagram showing the positions of spots formed on the photosensitive surface by the line head.

FIGS. 9A and 9B are diagrams showing a two-dimensional latent image formed on the photosensitive surface by the line head.

FIG. 10 is a diagram showing a comparative example of the line head.

FIGS. 11A, 11B, 12A and 12B are diagrams showing a state of spots formed by the comparative example of FIG. 10.

FIG. 13 is a diagram showing a second embodiment of the line head according to the invention.

FIG. 14 is a diagram showing another embodiment of the line head according to the invention.

FIG. 15 is a diagram showing a third embodiment of the line head according to the invention.

FIG. 16 is a diagram showing the positions of spots formed on the photosensitive surface by the line head of FIG. 15.

FIG. 17 is a diagram showing an image forming apparatus including a line head according to the invention.

### DESCRIPTION OF EXEMPLARY EMBODIMENTS

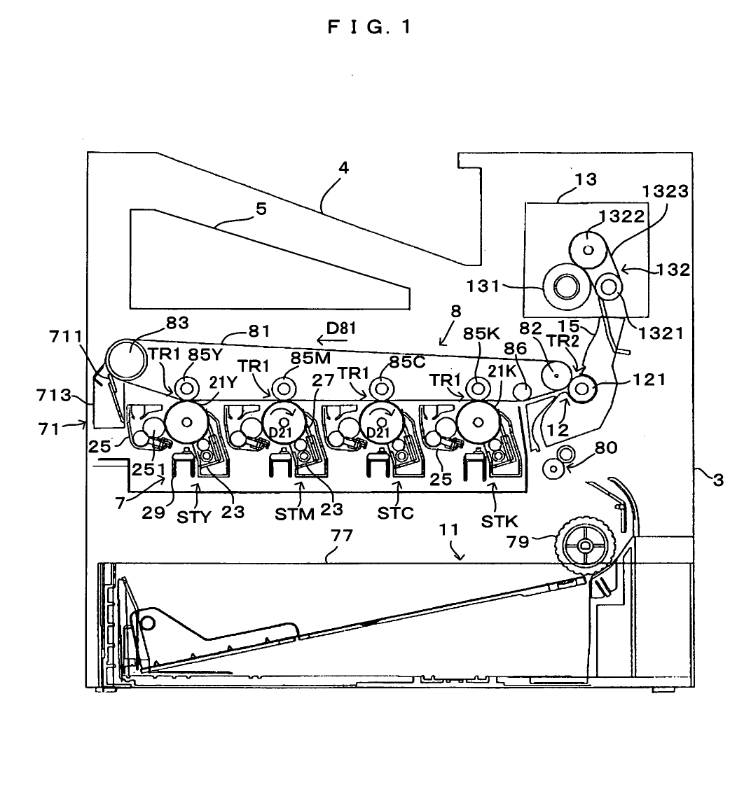

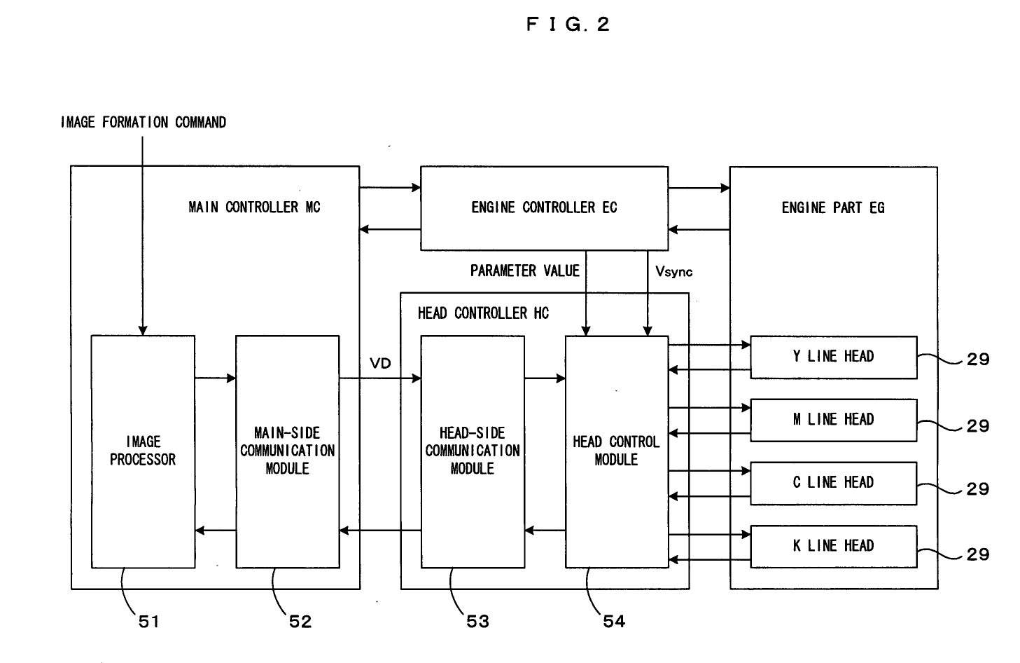

FIG. 1 is a diagram showing an embodiment of an image forming apparatus according to the invention, and FIG. 2 is a diagram showing the electrical construction of the image forming apparatus of FIG. 1. This apparatus is an image forming apparatus that can selectively execute a color mode for forming a color image by superimposing four color toners of black (K), cyan (C), magenta (M) and yellow (Y) and a monochromatic mode for forming a monochromatic image using only black (K) toner. FIG. 1 is a diagram corresponding to the execution of the color mode. In this image forming apparatus, when an image formation command is given from an external apparatus such as a host computer to a main controller MC having a CPU and memories, the main controller MC feeds a control signal and the like to an engine controller EC and feeds video data VD corresponding to the image formation command to a head controller HC. This head controller HC controls line heads 29 of the respective colors based on the video data VD from the main controller MC, a vertical synchronization signal Vsync from the engine controller EC and parameter values from the engine controller EC. In this way, an engine part EG performs a specified image forming operation to form an image corresponding to the image formation command on a sheet such as a copy sheet, transfer sheet, form sheet or transparent sheet for OHP.

An electrical component box 5 having a power supply circuit board, the main controller MC, the engine controller EC and the head controller HC built therein is disposed in a housing main body 3 of the image forming apparatus according to this embodiment. An image forming unit 7, a transfer belt unit 8 and a sheet feeding unit 11 are also arranged in the housing main body 3. A secondary transfer unit 12, a fixing unit 13, and a sheet guiding member 15 are arranged at the right side in the housing main body 3 in FIG. 1. It should be noted that the sheet feeding unit 11 is detachably mountable into the housing main body 3. The sheet feeding unit 11 and the transfer belt unit 8 are so constructed as to be detachable for repair or exchange respectively.

The image forming unit 7 includes four image forming stations STY (for yellow), STM (for magenta), STC (for cyan) and STK (for black) which form a plurality of images having different colors. Each of the image forming stations STY, STM, STC and STK includes a photosensitive drum 21 on the surface of which a toner image of the corresponding color is to be formed. Each photosensitive drum 21 is connected to its own driving motor and is driven to rotate at a specified speed in a direction of arrow D21 in FIG. 1, whereby the surface of the photosensitive drum 21 is transported in a sub scanning direction. Further, a charger 23, the line head 29, a developer 25 and a photosensitive drum cleaner 27 are arranged in a rotating direction around each photosensitive drum 21. A charging operation, a latent image forming operation and a toner developing operation are performed by these functional sections. Accordingly, a color image is formed by superimposing toner images formed by all the image forming stations STY, STM, STC and STK on a transfer belt 81 of the transfer belt unit 8 at the time of executing the color mode, and a monochromatic image is formed using only a toner image formed by the image forming station STK at the time of executing the monochromatic mode. Meanwhile, since the respective image forming stations of the image forming unit 7 are identically constructed, reference characters are given to only some of the image forming stations while being not given to the other image forming stations in order to facilitate the diagrammatic representation in FIG. 1.

The charger 23 includes a charging roller having the surface thereof made of an elastic rubber. This charging roller is constructed to be rotated by being held in contact with the surface of the photosensitive drum 21 at a charging position. As the photosensitive drum 21 rotates, the charging roller is rotated at the same circumferential speed in a direction driven by the photosensitive drum 21. This charging roller is connected to a charging bias generator (not shown) and charges the surface of the photosensitive drum 21 at the charging position where the charger 23 and the photosensitive drum 21 are in contact upon receiving the supply of a charging bias from the charging bias generator.

Each line head 29 includes a plurality of luminous elements arrayed in the axial direction of the photosensitive drum 21 (direction normal to the plane of FIG. 1) and is positioned separated from the photosensitive drum 21. Light beams are emitted from these luminous elements to the surface of the photosensitive drum 21 charged by the charger 23, thereby forming a latent image on this surface. In this embodiment, the head controller HC is provided to control the line heads 29 of the respective colors, and controls the respective line heads 29 based on the video data VD from the main controller MC and a signal from the engine controller EC. Specifically, in this embodiment, image data included in an image formation command is inputted to an image processor 51 of the main controller MC. Then, video data VD of the respective colors are generated by applying various image processings to the image data, and the video data VD are fed to the head controller HC via a main-side communication module 52. In the head controller HC, the video data VD are fed to a head control module 54 via a head-side communication module 53. Signals representing parameter values relating to the formation of a latent image and the vertical synchronization signal Vsync are fed to this head control module 54 from the engine controller EC as described above. Based on these signals, the video data VD and the like, the head controller HC generates signals for controlling the driving of the elements of the line heads 29 of the respective colors and outputs them to the respective line heads 29. In this way, the operations of the luminous elements in the respective line heads 29 are suitably controlled to form latent images corresponding to the image formation command.

In this embodiment, the photosensitive drum 21, the charger 23, the developer 25 and the photosensitive drum cleaner 27 of each of the image forming stations STY, STM, STC and STK are unitized as a photosensitive cartridge. Further, each photosensitive cartridge includes a nonvolatile memory for storing information on the photosensitive cartridge. Wireless communication is performed between the engine controller EC and the respective photosensitive cartridges. By doing so, the information on the respective photosensitive cartridges is transmitted to the engine controller EC and information in the respective memories can be updated and stored.

The developer 25 includes a developing roller 251 carrying toner on the surface thereof. By a development bias applied to the developing roller 251 from a development bias generator (not shown) electrically connected to the developing roller 251, charged toner is transferred from the developing roller 251 to the photosensitive drum 21 to develop the latent image formed by the line head 29 at a development position where the developing roller 251 and the photosensitive drum 21 are in contact.

The toner image developed at the development position in this way is primarily transferred to the transfer belt 81 at a primary transfer position TR1 to be described later where the transfer belt 81 and each photosensitive drum 21 are in contact after being transported in the rotating direction D21 of the photosensitive drum 21.

Further, in this embodiment, the photosensitive drum cleaner 27 is disposed in contact with the surface of the photosensitive drum 21 downstream of the primary transfer position TR1 and upstream of the charger 23 with respect to the rotating direction D21 of the photosensitive drum 21. This photosensitive drum cleaner 27 removes the toner remaining on the surface of the photosensitive drum 21 to clean after the primary transfer by being held in contact with the surface of the photosensitive drum.

The transfer belt unit 8 includes a driving roller 82, a driven roller (blade facing roller) 83 arranged to the left of the driving roller 82 in FIG. 1, and the transfer belt 81 mounted on these rollers and driven to turn in a direction of arrow D81 in FIG. 1 (conveying direction). The transfer belt unit 8 also includes four primary transfer rollers 85Y, 85M, 85C and 85K arranged to face in a one-to-one relationship with the photosensitive drums 21 of the respective image forming stations STY, STM, STC and STK inside the transfer belt 81 when the photosensitive cartridges are mounted. These primary transfer rollers 85Y, 85M, 85C and 85K are respectively electrically connected to a primary transfer bias generator not shown. As described in detail later, at the time of executing the color mode, all the primary transfer rollers 85Y, 85M, 85C and 85K are positioned on the sides of the image forming stations STY, STM, STC and STK as shown in FIG. 1, whereby the transfer belt 81 is pressed into contact with the photosensitive drums 21 of the image forming stations STY, STM, STC and STK to form the primary transfer positions TR1 between the respective photosensitive drums 21 and the transfer belt 81. By applying primary transfer biases from the primary transfer bias generator to the primary transfer rollers 85Y, 85M, 85C and 85K at suitable timings, the toner images formed on the surfaces of the respective photosensitive drums 21 are transferred to the surface of the transfer belt 81 at the corresponding primary transfer positions TR1 to form a color image.

On the other hand, out of the four primary transfer rollers 85Y, 85M, 85C and 85K, the color primary transfer rollers 85Y, 85M, 85C are separated from the facing image forming stations STY, STM and STC and only the monochromatic primary transfer roller 85K is brought into contact with the image forming station STK at the time of executing the monochromatic mode, whereby only the monochromatic image forming station STK is brought into contact with the transfer belt 81. As a result, the primary transfer position TR1 is formed only between the monochromatic primary transfer roller 85K and the image forming station STK. By applying a primary transfer bias at a suitable timing from the primary transfer bias generator to the monochromatic primary transfer roller 85K, the toner image formed on the surface of the photosensitive drum 21 is transferred to the surface of the transfer belt 81 at the primary transfer position TR1 to form a monochromatic image.

The transfer belt unit 8 further includes a downstream guide roller 86 disposed downstream of the monochromatic primary transfer roller 85K and upstream of the driving roller 82. This downstream guide roller 86 is so disposed as to come into contact with the transfer belt 81 on an internal common tangent to the primary transfer roller 85K and the photosensitive drum 21 at the primary transfer position TR1 formed by the contact of the monochromatic primary transfer roller 85K with the photosensitive drum 21 of the image forming station STK.

The driving roller 82 drives to rotate the transfer belt 81 in the direction of the arrow D81 and doubles as a backup roller for a secondary transfer roller 121. A rubber layer having a thickness of about 3 mm and a volume resistivity of 1000 kΩ·cm or lower is formed on the circumferential surface of the driving roller 82 and is grounded via a metal shaft, thereby serving as an electrical conductive path for a secondary transfer bias to be supplied from an unillustrated secondary transfer bias generator via the secondary transfer roller 121. By providing the driving roller 82 with the rubber layer having high friction and shock absorption, an impact caused upon the entrance of a sheet into a contact part (secondary transfer position TR2) of the driving roller 82 and the secondary transfer roller 121 is unlikely to be transmitted to the transfer belt 81 and image deterioration can be prevented.

The sheet feeding unit 11 includes a sheet feeding section which has a sheet cassette 77 capable of holding a stack of sheets, and a pickup roller 79 which feeds the sheets one by one from the sheet cassette 77. The sheet fed from the sheet feeding section by the pickup roller 79 is fed to the secondary transfer position TR2 along the sheet guiding member 15 after having a sheet feed timing adjusted by a pair of registration rollers 80.

The secondary transfer roller 121 is provided freely to abut on and move away from the transfer belt 81, and is driven to abut on and move away from the transfer belt 81 by a secondary transfer roller driving mechanism (not shown). The fixing unit 13 includes a heating roller 131 which is freely rotatable and has a heating element such as a halogen heater built therein, and a pressing section 132 which presses this heating roller 131. The sheet having an image secondarily transferred to the front side thereof is guided by the sheet guiding member 15 to a nip portion formed between the heating roller 131 and a pressure belt 1323 of the pressing section 132, and the image is thermally fixed at a specified temperature in this nip portion. The pressing section 132 includes two rollers 1321 and 1322 and the pressure belt 1323 mounted on these rollers. Out of the surface of the pressure belt 1323, a part stretched by the two rollers 1321 and 1322 is pressed against the circumferential surface of the heating roller 131, thereby forming a sufficiently wide nip portion between the heating roller 131 and the pressure belt 1323. The sheet having been subjected to the image fixing operation in this way is transported to the discharge tray 4 provided on the upper surface of the housing main body 3.

Further, a cleaner 71 is disposed facing the blade facing roller 83 in this apparatus. The cleaner 71 includes a cleaner blade 711 and a waste toner box 713. The cleaner blade 711 removes foreign matters such as toner remaining on the transfer belt after the secondary transfer and paper powder by holding the leading end thereof in contact with the blade facing roller 83 via the transfer belt 81. Foreign matters thus removed are collected into the waste toner box 713. Further, the cleaner blade 711 and the waste toner box 713 are constructed integral to the blade facing roller 83. Accordingly, if the blade facing roller 83 moves as described next, the cleaner blade 711 and the waste toner box 713 move together with the blade facing roller 83.

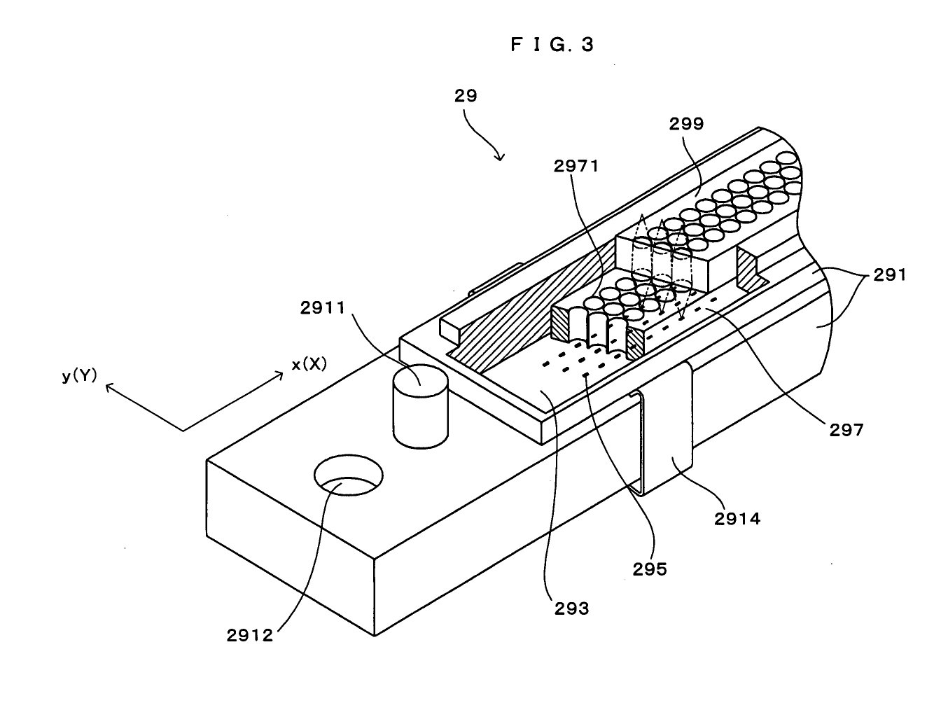

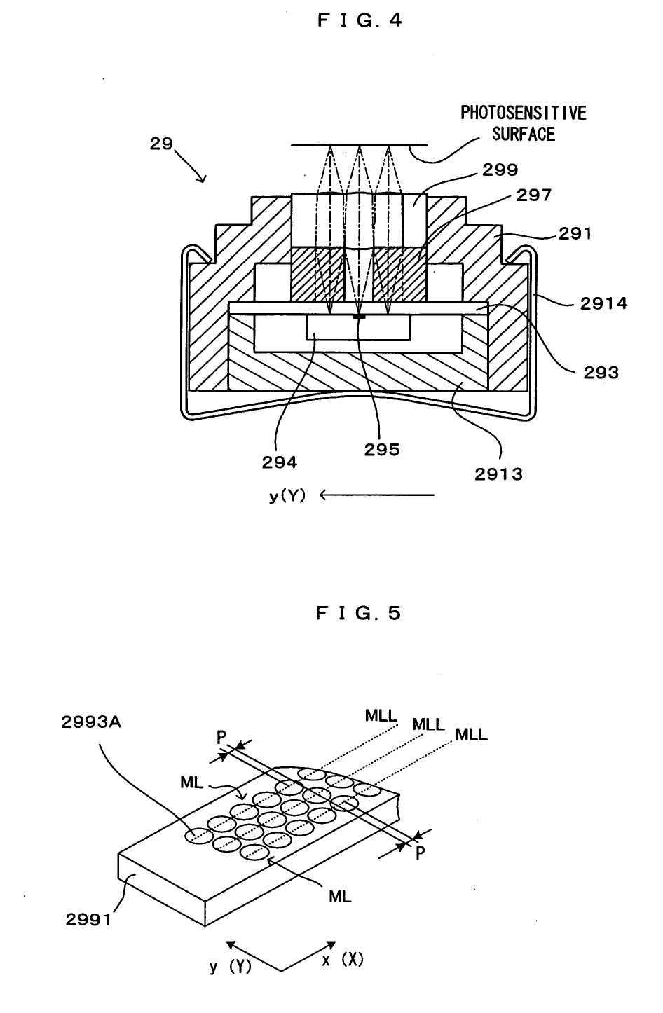

FIG. 3 is a perspective view schematically showing a first embodiment of the line head (exposure unit) according to the invention, and FIG. 4 is a section along width direction of the embodiment of the line head (exposure unit) according to the invention. In this embodiment, the line head 29 is arranged to face the surface of the photosensitive drum such that the longitudinal direction x of the line head 29 is parallel to the main scanning direction X and the width direction y substantially normal to the longitudinal direction x is parallel to the sub scanning direction Y In other words, the main scanning direction X and the sub scanning direction Y of the photosensitive drum 21 correspond to the longitudinal direction x and the width direction y of the line head 29 in this embodiment.

The line head 29 includes a case 291 which extends parallel to the longitudinal direction x. A positioning pin 2911 and a screw insertion hole 2912 are provided at each of the opposite ends of the case 291. The line head 29 is positioned with respect to the photosensitive drum 21 by fitting the positioning pins 2911 into positioning holes (not shown) formed in a photosensitive drum cover (not shown) which covers the photosensitive drum 21 and is positioned with respect to the photosensitive drum 21. Further, the line head 29 is fixed with respect to the photosensitive drum 21 by screwing fixing screws into screw holes (not shown) of the photosensitive drum cover through the screw insertion holes 2912 to fix.

The case 291 carries a microlens array 299 at a position facing the surface of the photosensitive drum 21, and includes, inside thereof, a light shielding member 297 and a glass substrate 293 in this order closer to the microlens array 299. A plurality of luminous element groups 295 are arranged on the underside surface of the glass substrate 293 (surface opposite to the one where the microlens array 299 is disposed out of two surfaces of the glass substrate 293). Specifically, the plurality of luminous element groups 295 are two-dimensionally arranged on the underside surface of the glass substrate 293 while being spaced apart at specified intervals from each other in the longitudinal direction x and in the width direction y. Here, each of the plurality of luminous element groups 295 is composed of a plurality of two-dimensionally arranged luminous elements, and is described later. In this embodiment, an organic EL (electroluminescence) device of bottom emission type is used as the luminous element. In other words, the organic EL devices are arranged on the underside surface of the glass substrate 293 as the luminous elements. When the respective luminous elements are driven by driving circuits (not shown) formed on this glass substrate 293, light beams are emitted from the luminous elements in a direction toward the photosensitive drum 21. These light beams are headed for the light shielding member 297 via the glass substrate 293.

The light shielding member 297 is formed with a plurality of light guiding holes 2971 which are in a one-to-one correspondence with the plurality of luminous element groups 295. Each of the light guiding holes 2971 is in the form of a substantial cylinder whose central axis is parallel to a normal line to the surface of the glass substrate 293, and penetrates the light shielding member 297. Thus, all the light beams emitted from the luminous elements belonging to one luminous element group 295 are headed for the microlens array 299 via the same light guiding hole 2971, and the interference of light beams emitted from different luminous element groups 295 is prevented by means of the light shielding member 297. The light beams having passed through the light guiding holes 2971 formed in the light shielding member 297 are imaged as spots on the surface of the photosensitive drum 21 by means of the microlens array 299. It should be noted that the specific construction of the microlens array 299 and the imaged state of the light beams by the microlens array 299 are described in detail later.

As shown in FIG. 4, an underside lid 2913 is pressed to the case 291 via the glass substrate 293 by a retainer 2914. Specifically, the retainer 2914 has an elastic force to press the underside lid 2913 toward the case 291, and seals the inside of the case 291 light-tight (that is, so that light does not leak from the inside of the case 291 and so that light does not intrude into the case 291 from the outside) by pressing the underside lid 2913 by means of the elastic force. It should be noted that a plurality of the retainers 2914 are provided at a plurality of positions in the longitudinal direction of the case 291. The luminous element groups 295 are covered with a sealing member 294.

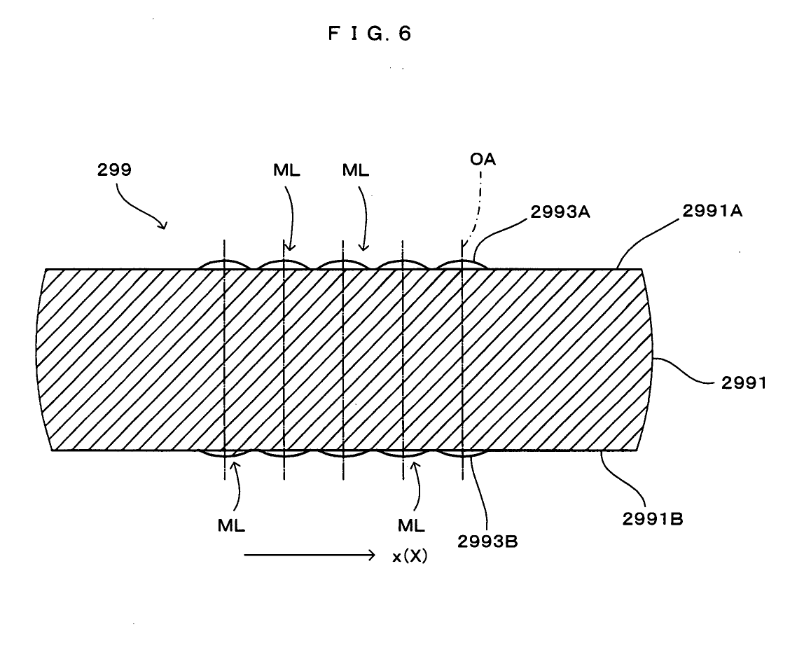

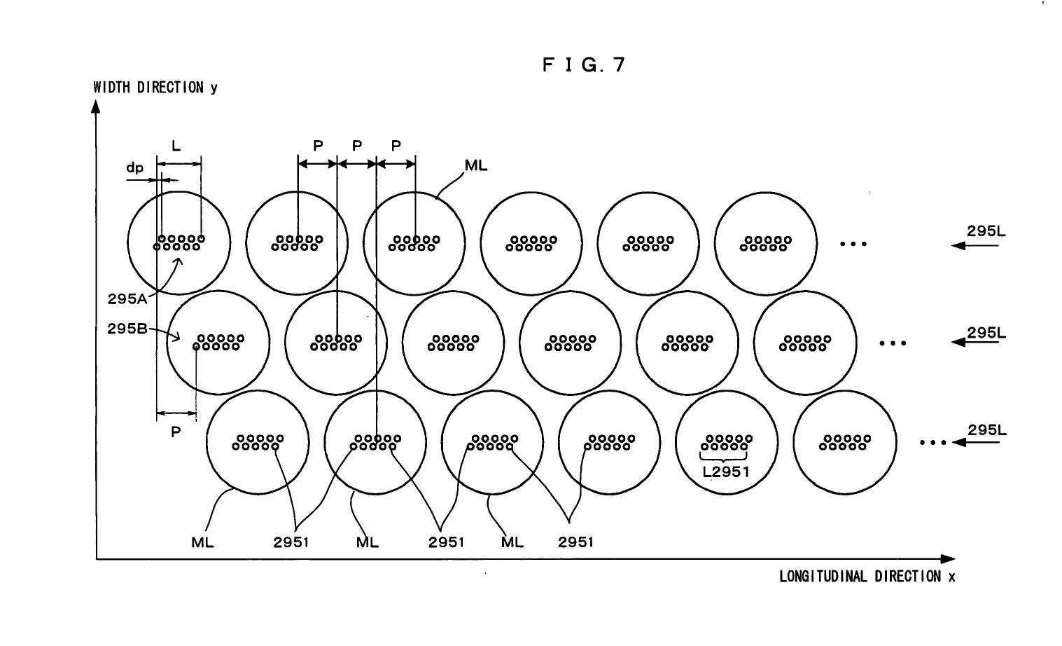

FIG. 5 is a perspective view schematically showing the microlens array, and FIG. 6 is a longitudinal section of the microlens array. The microlens array 299 includes a glass substrate 2991 and a plurality of lens pairs each comprised of two lenses 2993A and 2993B arranged in one-to-one correspondence at the opposite sides of the glass substrate 2991. These lenses 2993A and 2993B can be formed of resin for instance.

Specifically, a plurality of lenses 2993A are arranged on a top surface 2991A of the glass substrate 2991, and a plurality of lenses 2993B are so arranged on an underside surface 2991B of the glass substrate 2991 as to correspond one-to-one to the plurality of lenses 2993A. Further, two lenses 2993A and 2993B constituting a lens pair have a common optical axis OA. These plurality of lens pairs are arranged in a one-to-one correspondence with the plurality of luminous element groups 295. Specifically, the plurality of lens pairs are two-dimensionally arranged and spaced apart from each other at specified intervals in the longitudinal direction x and in the width direction y corresponding to the arrangement of the luminous element groups 295. More specifically, in this microlens array 299, a microlens ML including the lens pair comprised of the lenses 2993A and 2993B and the glass substrate 2991 located between the lens pair corresponds to an “imaging lens” of the invention. A plurality of (three in this embodiment) lens lines MLL, each of which is comprised of a plurality of these microlenses ML aligned in the longitudinal direction x, are arranged in the width direction y, thereby arranging a plurality of microlenses ML in a staggered arrangement and at positions different from each other in the longitudinal direction. Particularly in this embodiment, microlenses ML are arranged such that a distance P between the optical axes in the longitudinal direction x are constant (FIG. 5). Further, all the microlenses ML are structured identically and have the same magnification m. It should be noted that the microlenses ML having the magnification m whose value is negative are used in this embodiment. However, it is needless to say that the magnification m may be set to a positive value.

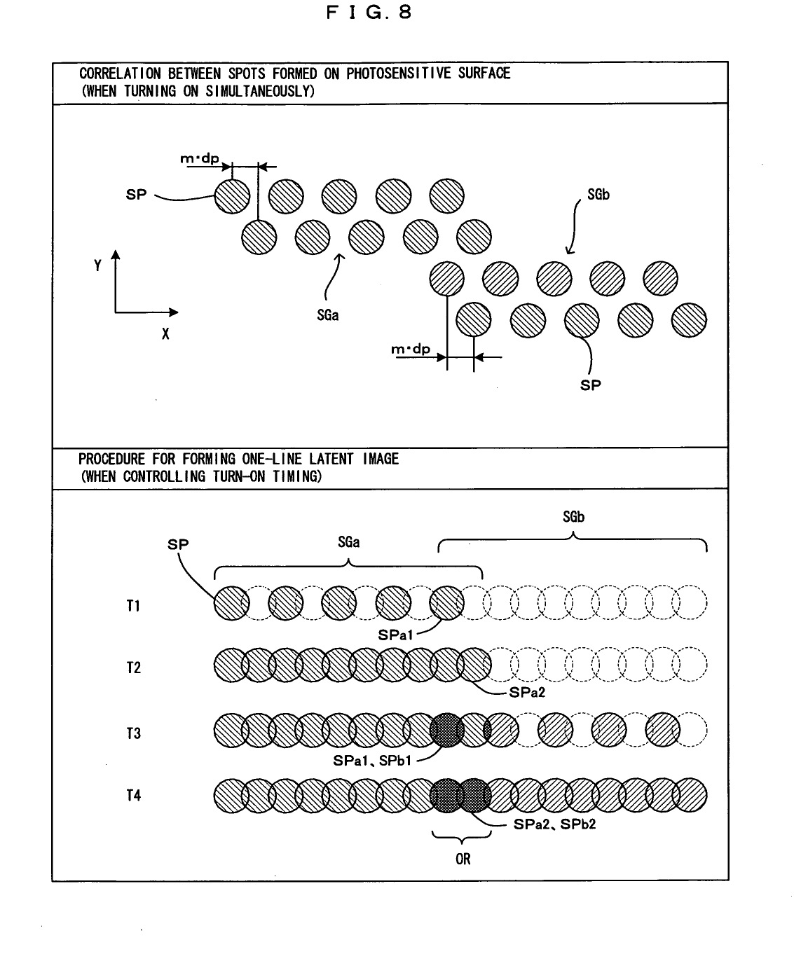

FIG. 7 is a diagram showing the arrangement relationship of the luminous element groups and the microlenses in the line head. In this line head, a plurality of luminous element groups 295 having the same construction are arranged in one-to-one correspondence relationship with the microlenses ML arranged as described above. Specifically, the luminous element group line 295L is formed by aligning a specified number of luminous element groups 295 while spacing them apart from each other in the longitudinal direction x. A plurality of (“three” in this embodiment) luminous element group lines 295L are arranged in the width direction y, wherein a plurality of luminous element groups 295 are arranged in a staggered manner. A spacing between the adjacent luminous element groups 295 in the longitudinal direction x coincides with a distance P between optical axes of the microlenses ML.

Each luminous element group 295 includes ten luminous elements 2951, which are arranged as follows. Specifically, in each luminous element group 295, five luminous elements 2951 are aligned at specified pitches (=twice the element pitch dp) in the longitudinal direction x to form the luminous element line L2951. Further, two luminous element lines L2951 are arranged in the width direction y. Furthermore, a shift amount of the luminous element lines L2951 in the longitudinal direction x is the element pitch dp. Thus, in each luminous element group 295, all the luminous elements 2951 are arranged at mutually different longitudinal positions spaced apart by the element pitch dp. Accordingly, light beams emitted from the ten luminous elements 2951 in each luminous element group 295 are focused on the surface of the photosensitive drum 21 (hereinafter, “photosensitive surface”) at mutually different positions in the main scanning direction X by the microlens ML. In this way, ten spots are formed side by side in the main scanning direction X to form a spot group.

Further, in this embodiment, the line head 29 is constructed so as to satisfy the following inequality:

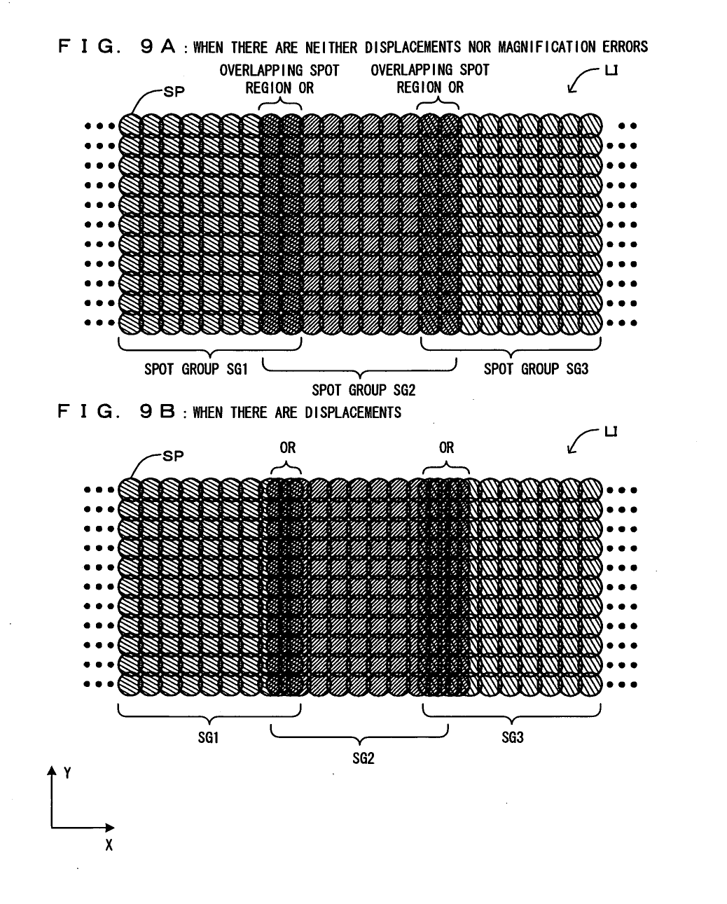

L·m>P−m·dp (1)

where the symbol L denotes the inter-element distance between the two luminous elements 2951 which are farthest from each other in each luminous element group 295 in the longitudinal direction x (see FIG. 7). In the line head 29 having the structure above therefore, the spot groups which are formed adjacent to each other in the main scanning direction X partly overlap with each other. This will now be described in detail with reference to FIG. 8.

FIG. 8 is a diagram showing the positions of spots formed on the photosensitive surface by the line head, and diagrammatically shows a state where spots are formed by two luminous element groups, for example the luminous element groups 295A and 295B in FIG. 7. A “spot group SGa” in FIG. 8 represents a group of spots SP formed by the luminous element group 295A at the upstream side (left side in FIG. 7), whereas a “spot group SGb” represents a group of spots SP formed by the luminous element group 295B at the downstream side (right side in FIG. 7). As shown in an upper part of FIG. 8, if the luminous elements 2951 are simultaneously turned on, the spot groups Sga and SGb formed on the photosensitive surface are also two-dimensionally arranged.

Accordingly, in this embodiment, the luminous elements 2951 constituting the luminous element line L2951 are turned on to emit light beams at timings in conformity with a rotational movement of the photosensitive drum 21 in each luminous element line L2951 as shown in a lower part of FIG. 8. In other words, the turn-on timings of the luminous element lines L2951 constituting the luminous element groups 295A and 295B are differentiated as follows in conformity with the rotational movement of the photosensitive drum 21.
(a) Timing T1: Turn the upper luminous element line L2951 of the luminous element group 295A on
(b) Timing T2: Turn the lower luminous element line L2951 of the luminous element group 295A on
(c) Timing T3: Turn the upper luminous element line L2951 of the luminous element group 295B on
(d) Timing T4: Turn the lower luminous element line L2951 of the luminous element group 295A on
   Thus, the spots SP formed by the upper luminous element lines and those formed by the lower luminous element lines can be aligned in the main scanning direction X only by this timing adjustment. In this way, the spots SP can be aligned in a line in the main scanning direction X by a simple emission timing adjustment.

Here, what should be further noted is that the spot groups Sga and SGb formed adjacent to each other in the main scanning direction X partly overlap to form an overlapping spot region OR in this embodiment, due to the fact that the above inequality (1) is satisfied. Specifically, in this overlapping spot region OR, some (spots SPa1 and SPa2 in FIG. 8) of the spots by the luminous element group 295A and some (spots SPb1 and SPb2 in FIG. 8) of the spots by the luminous element group 295B overlap. In this specification, the spots SPa1, SPa2, SPb1 and SPb2 forming the overlapping spot region OR are called “overlapping spots”.

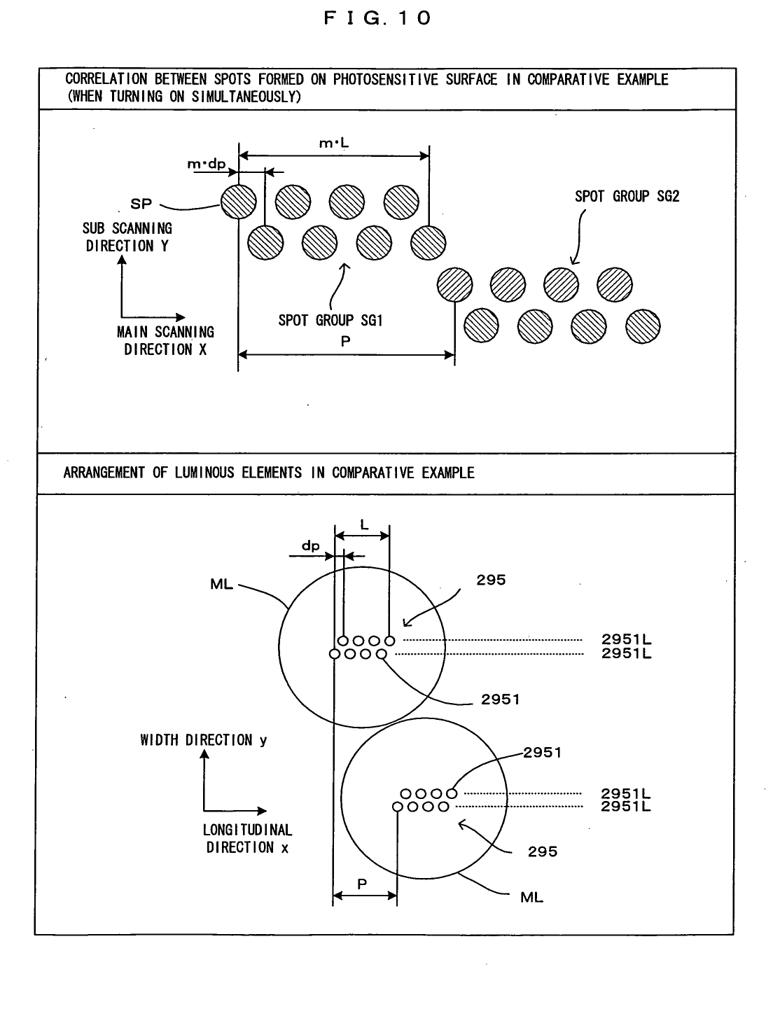

If exposure is made to the photosensitive surface using the line head 29 constructed as above, a two-dimensional latent image L1 as shown in FIGS. 9A and 9B is obtained. Specifically, the spot groups adjacent to each other form overlapping spot regions OR by partly overlapping. Thus, the formation of clearances between the spot groups SG can be prevented and good spot formation can be carried out, not only when there are neither displacements nor magnification errors (FIG. 9A), but also when the relative positional relationship of the luminous element groups 295 and the microlenses ML is slightly deviated or there are magnification errors of the microlenses ML (FIG. 9B). Further, by forming an image using such a line head 29, a high-quality toner image can be formed without generating vertical lines.

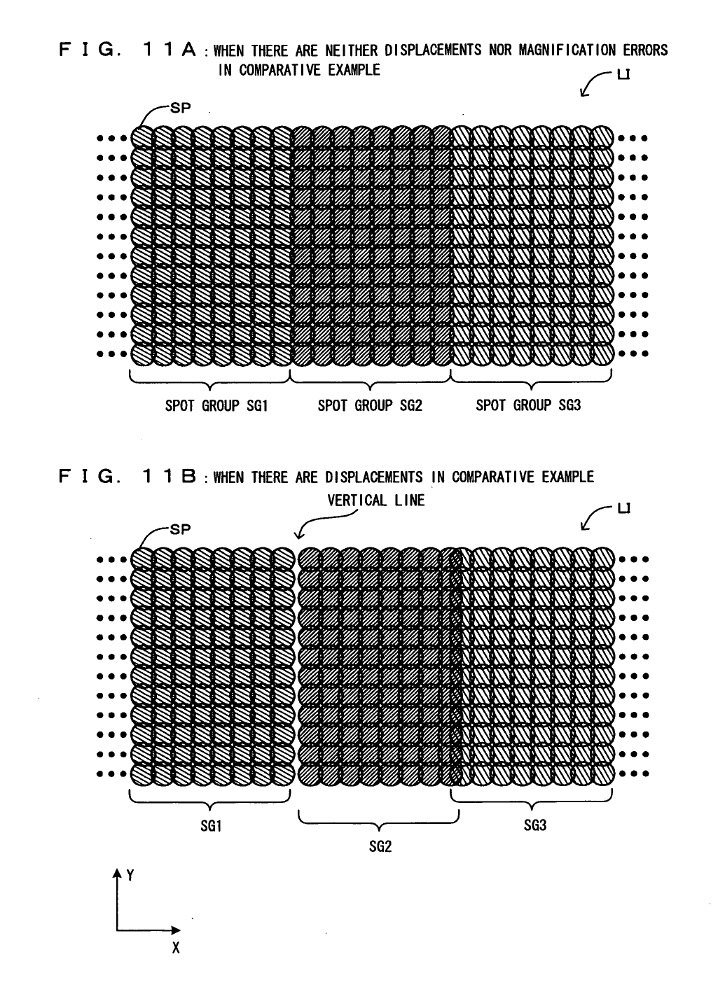

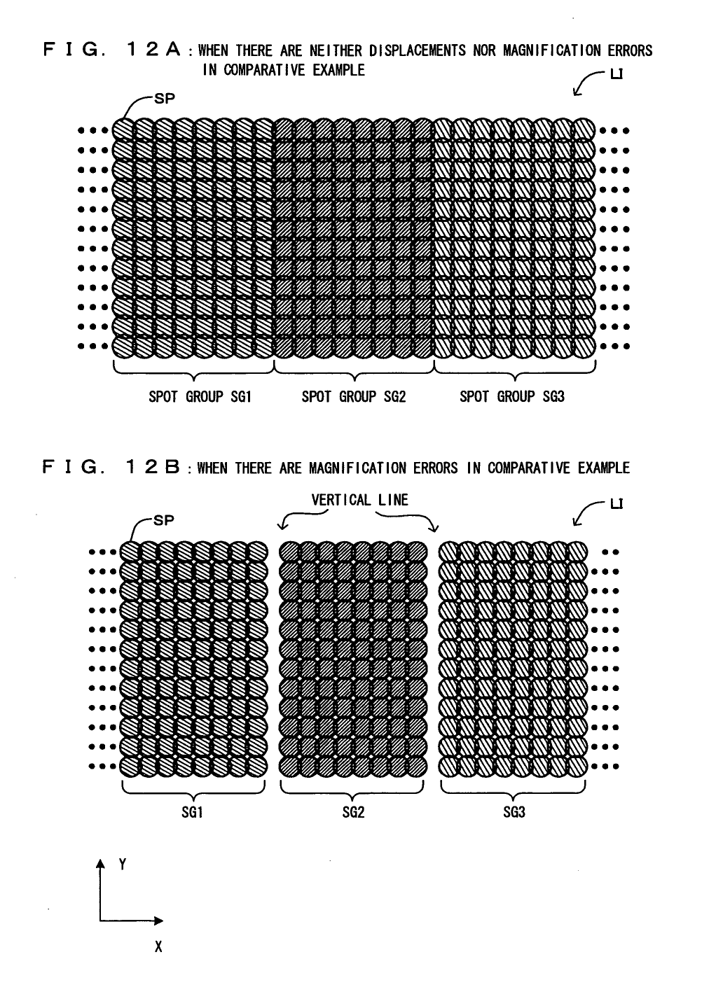

FIG. 10 is a diagram showing a comparative example of the line head, and FIGS. 11A, 11B, 12A and 12B are diagrams showing a state of spots formed by the comparative example of FIG. 10. Here, the meaning of the above inequality is made clearer with reference to FIGS. 10, 11A, 11B, 12A and 12B.

In this comparative example, as shown in a lower part of FIG. 10, four luminous elements 2951 are aligned at specified pitches (=twice the element pitch dp) in the longitudinal direction x to form the luminous element line 2951L in each luminous element group 295. Further, two luminous element lines 2951L are arranged in the width direction y. Further, the luminous element lines 2951L are shifted from each other by the element pitch dp in the longitudinal direction x. The line head 29 is constructed such that the following equality is satisfied. L·m=P−m·dp

Therefore, when the luminous elements 2951 of the comparative example constructed in this way are turned on, all the spots SP are formed at mutually different positions in the main scanning direction X while being spaced apart by a spot pitch (m·dp) as is clear from an upper part of FIG. 10.

Accordingly, if the spots SP are formed on the photosensitive surface by the line head according to the comparative example, good spot formation is carried out if there are neither displacements nor magnification errors (see FIGS. 11A and 12A). However, if the mutual positional relationship of the luminous element groups 295 and the microlenses ML is slightly deviated to cause a displacement, spot groups SG1 and SG2 are separated from each other to form a vertical line as shown in FIG. 11B. Also in the case of a magnification error in the microlens array 299, spot groups SG1 to SG3 are separated from each other to form vertical lines as shown in FIG. 12B.

On the contrary, the line head 29 is so constructed as to satisfy the above inequality (1) according to this embodiment as described above. Thus, spots can be formed without causing these problems. In an image forming apparatus using thus constructed line head 29 as an exposing device, high-quality images can be formed.

Since angle of view of the microlenses ML regarding light beams from the luminous elements 2951 located at the ends of the luminous element groups 295 is large, there are cases where the diameter of the spots SP increases and light quantity decrease due to an aberration deterioration of the microlenses ML. If such a problem needs to be considered, it is preferable to construct the respective luminous element groups 295 as follows.

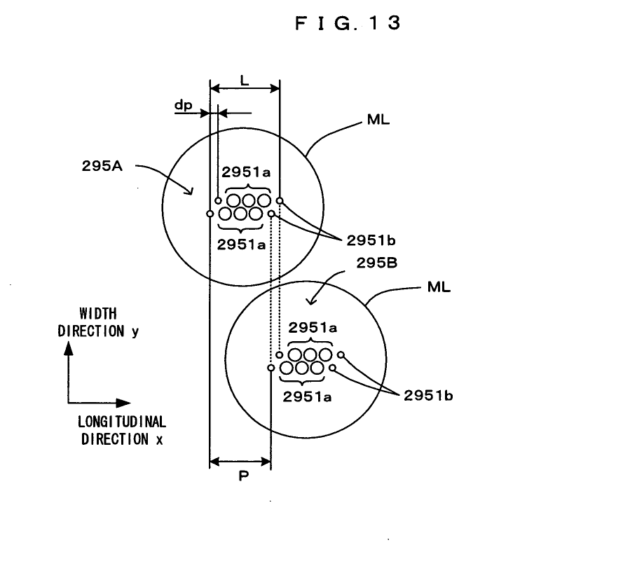

FIG. 13 is a diagram showing a second embodiment of the line head according to the invention. In this embodiment, luminous elements constituting each luminous element group 295 are divided into two types of luminous elements different from each other. One type are luminous elements 2951b located at the ends of the luminous element groups 295 to form overlapping spots, and the other type are remaining luminous elements 2951a, which respectively form independent spots. In this embodiment, the element diameter of the luminous elements 2951b is smaller than that of the luminous elements 2951a.

In the case of using the luminous element groups 295 constructed as above, the diameter of spots formed by the luminous elements 2951b, that is, that of overlapping spots, increases due to the aberration deterioration of the microlenses ML. Thus, the diameter of the overlapping spots becomes substantially the same as that of spots SP formed by the luminous elements 2951a, whereby the spot diameters can be made uniform. By making the element diameter of the respective luminous elements 2951b smaller, the light quantities of the respective overlapping spots decrease. However, in an overlapping spot region OR, overlapping spots formed by the luminous elements 2951b of the luminous element groups adjacent to each other in the longitudinal direction x (luminous element groups 295A and 295B in FIG. 13 for instance), that is, by two luminous elements 2951b overlap. Thus, about the same light quantity as the spots SP formed by the luminous elements 2951a can be obtained. Therefore, light quantity reductions caused by the aberration deterioration of the microlenses ML can be solved.

As described above, according to the line head of this embodiment, the spot diameters and the light quantities can be made uniform even if the aberration of the microlenses ML is deteriorated. Further, it becomes unnecessary to require strict optical characteristics for the design of the microlenses ML, a relatively large degree of freedom in designing can be obtained and the cost of the microlens array 299 can be reduced.

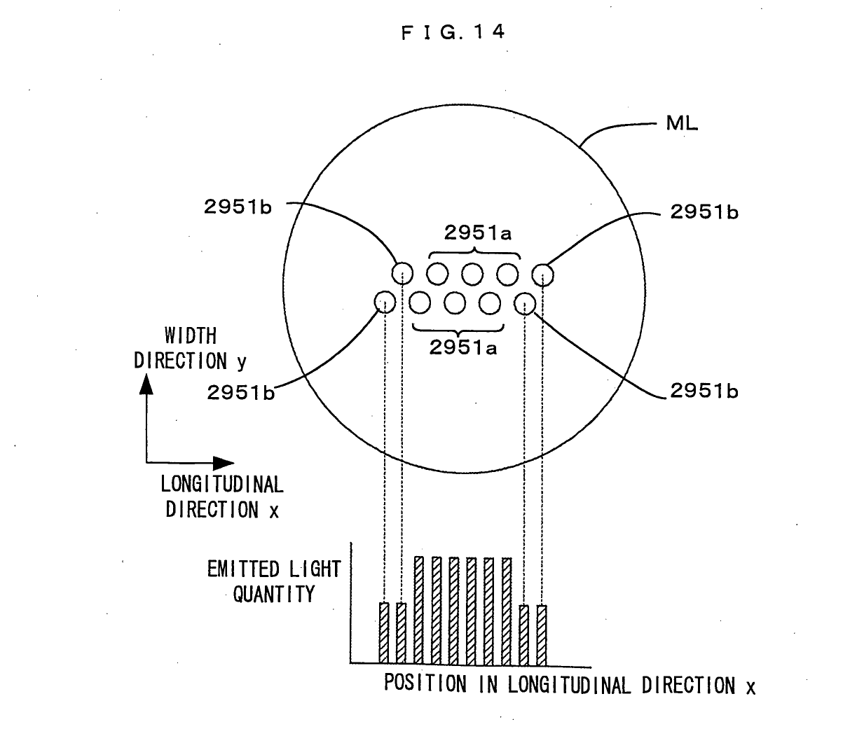

The following construction is preferable for a problem that light quantity in the overlapping spot regions OR is larger than that in other regions. This is described below with reference to FIG. 14.

FIG. 14 is a diagram showing another embodiment of the line head according to the invention. In this embodiment as well, each luminous element group 295 includes luminous elements 2951b for forming overlapping spots and luminous elements 2951a for forming independent spots similar to the embodiment shown in FIG. 13. Further, in this embodiment, the emitted light quantity of the luminous elements 2951b is smaller than that of the luminous elements 2951a. Accordingly, in the overlapping spot region OR, overlapping spots are formed by two luminous elements 2951b and the light quantity in the overlapping spot region OR is about the same as that in the other region (region where spots are formed by the luminous elements 2951a). Thus, even if the overlapping spot regions OR are provided, the light quantities on the photosensitive surface can be made uniform.

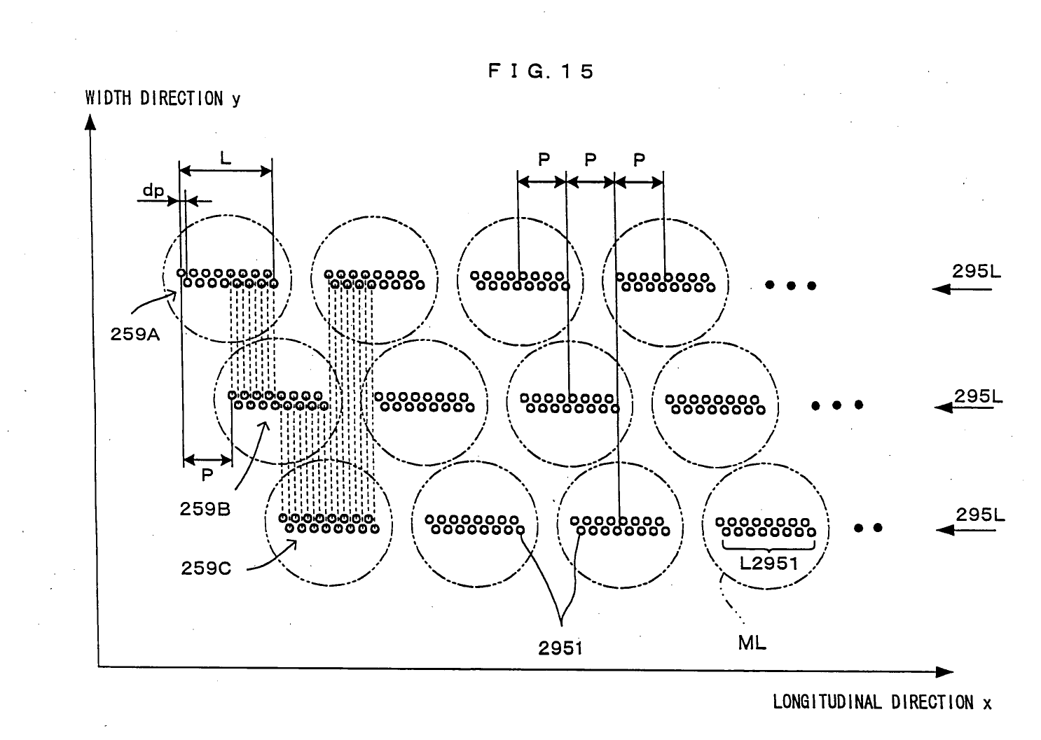

The invention is not limited to the above embodiments and various changes other than the aforementioned ones can be made without departing from the gist of the invention. For example, although some of the luminous elements constituting the luminous element groups 295 function as luminous elements for forming the overlapping spots in the above embodiment, all the luminous elements may function as luminous elements for forming overlapping spots as shown in FIG. 15.

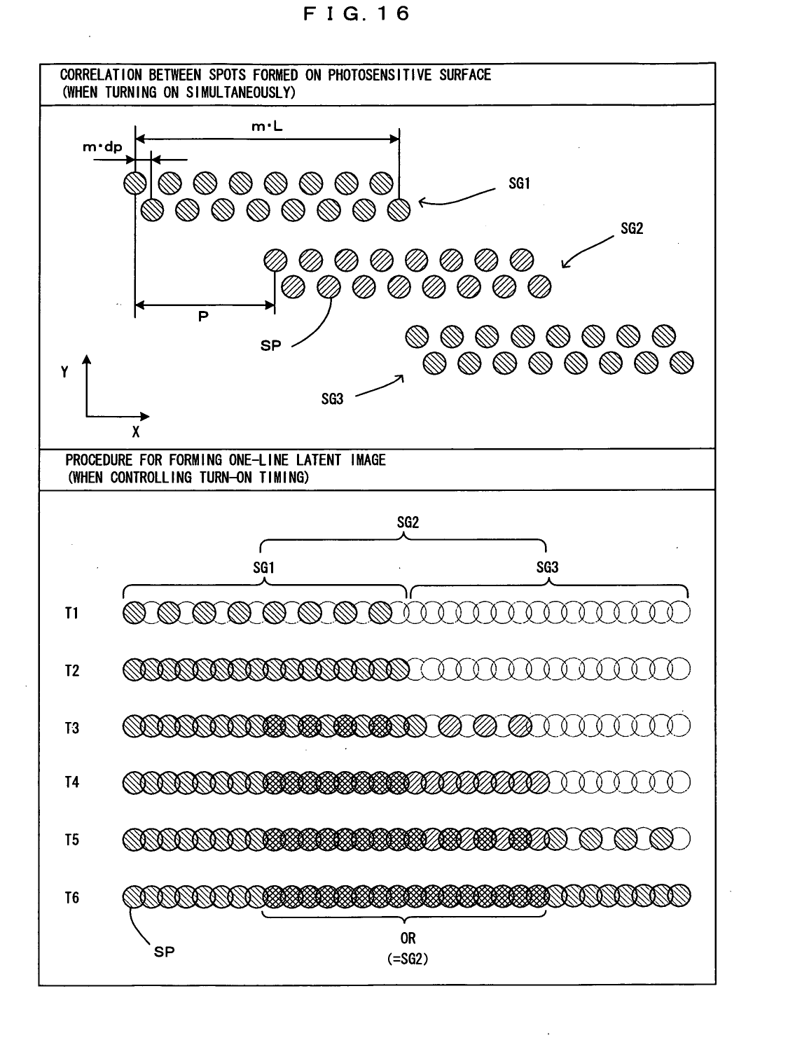

FIG. 15 is a diagram showing a third embodiment of the line head according to the invention. In this embodiment, each luminous element group 295 includes sixteen luminous elements 2951. More specifically, in each luminous element group 295, eight luminous elements 2951 are aligned at specified pitches (=twice the element pitch dp) in the longitudinal direction x to form a luminous element line L2951. Further, two luminous element lines L2951 are arranged in the width direction y. Furthermore, a shift amount of the luminous element lines L2951 in the longitudinal direction x is the element pitch dp. Thus, in each luminous element group 295, all the luminous elements 2951 are arranged at mutually different longitudinal positions spaced apart by the element pitch dp. As a matter of course, in this embodiment also, the above inequality is satisfied, and all the luminous elements 2951 form overlapping spots by an operation as shown in FIG. 16.

FIG. 16 is a diagram showing the positions of spots formed on the photosensitive surface by the line head of FIG. 15. In FIG. 16 are shown spots SP formed by three luminous element groups 295A to 295C shown in FIG. 15. These three luminous element groups 295A to 295C are provided in correspondence with three microlenses ML adjacent to each other and are also adjacent to each other in the longitudinal direction x as shown in FIG. 15. Thus, the luminous element groups 295A, 295B and 295C correspond to a “first luminous element group”, a “second luminous element group” and a “third luminous element group” of the invention, respectively.

Each luminous element line L2951 is constructed such that the luminous elements 2951 constituting the luminous element line L2951 are turned on to emit light beams at timings in conformity with a rotational movement of the photosensitive drum 21. In other words, the turn-on timings of the luminous element lines L2951 constituting the luminous element groups 295A to 295C are differentiated as follows in conformity with the rotational movement of the photosensitive drum 21.
(a) Timing T1: Turn the upper luminous element line L2951 of the luminous element group 295A on
(b) Timing T2: Turn the lower luminous element line L2951 of the luminous element group 295A on
(c) Timing T3: Turn the upper luminous element line L2951 of the luminous element group 295B on
(d) Timing T4: Turn the lower luminous element line L2951 of the luminous element group 295B on
(e) Timing T5: Turn the upper luminous element line L2951 of the luminous element group 295C on
(f) Timing T6: Turn the lower luminous element line L2951 of the luminous element group 295C on
   Thus, the spots SP formed by the upper luminous element lines and those formed by the lower luminous element lines can be aligned in the main scanning direction X only by this timing adjustment. In this way, the spots SP can be aligned in a line in the main scanning direction X by a simple emission timing adjustment. Further, the overlapping spot region OR formed in this way coincides with the spot region by the luminous element group 295B. Furthermore, in this embodiment, the overlapping spot region OR becomes wider as compared to the embodiment shown in FIG. 7 and the like, whereby the formation of vertical lines can be reliably prevented even in the case of larger displacements and magnification errors.

Further, in the above embodiments, two luminous element lines L2951 formed by aligning five or eight luminous elements 2951 at specified pitches in the longitudinal direction x are arranged in the width direction y. However, the configuration and arrangement (in other words, arrangement mode of a plurality of luminous elements) of the luminous element lines L2951 are not limited to these. In short, it is sufficient to arrange a plurality of luminous elements 2951 at different positions in the longitudinal direction x.

Although the organic EL (electroluminescence) devices are used as the luminous elements 2951 in the above embodiments, the specific construction of the luminous elements 2951 is not limited to this and LEDs (light emitting diodes) may be, for example, used as the luminous elements 2951.

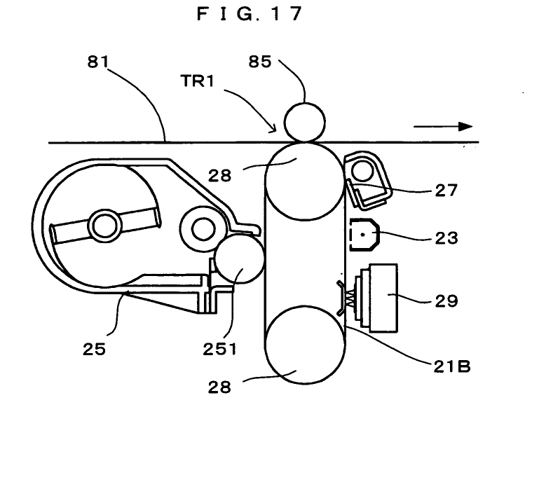

Although the surface of the photosensitive drum 21 serves as the “surface-to-be-scanned” of the invention in the above embodiments, the application subject of the invention is not limited to this. For example, the invention is also applicable to an apparatus using a photosensitive belt as shown in FIG. 17.

FIG. 17 is a diagram showing an image forming apparatus including a line head according to the invention. This embodiment largely differs from the embodiment shown in FIG. 3 in the mode of the photosensitive member. Specifically, in this embodiment, a photosensitive belt 21B is used instead of the photosensitive drum 21. Since the other constructions are similar to the above embodiment, the identical constructions are identified by the same or corresponding reference numerals and are not described.

In this embodiment, the photosensitive belt 21B is mounted on two rollers 28 extending in the main scanning direction X. This photosensitive belt 21B is driven and rotated in a specified direction of rotation D21 by an unillustrated drive motor. Further, a charger 23, a line head 29, a developing device 25 and a photosensitive belt cleaner 27 are arranged along the direction of rotation D21 around this photosensitive belt 21B. A charging operation, a latent image forming operation and a toner developing operation are performed by these functional devices.

In this embodiment, the line head 29 is arranged to face a position where the photosensitive belt 21B is flat. Accordingly, light beams for exposure from the line head 29 is vertically irradiated to the surface of the photosensitive belt 21B to form spots. Thus, the spots are irradiated to the flat surface of the photosensitive member, thereby being better formed. This is because, if the photosensitive drum 21 is a surface-to-be-scanned, the deformation of spots SP are unavoidable since the photosensitive surface is a curvature surface. On the other hand, in the apparatus using the photosensitive belt 21B, the photosensitive surface becomes flat, whereby the deformation of the spots SP can be prevented and better spot formation can be carried out.

Although the invention is applied to the color image forming apparatus in the above embodiment, the application thereof is not limited to this and the invention is also applicable to monochromatic image forming apparatuses which form monochromatic images.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A line head, comprising:
a lens array in which a plurality of imaging lenses whose absolute value of magnification is m are arranged in a longitudinal direction which corresponds to a main scanning direction for a surface-to-be-scanned; and
a plurality of luminous element groups which are disposed in one-to-one correspondence to the plurality of imaging lenses, wherein
in each one of the plurality of luminous element groups, the plurality of luminous elements are arranged at mutually different positions in the longitudinal direction spaced apart by an element pitch dp, the plurality of luminous elements of this luminous element group are respectively turned on to emit light beams at timings in conformity with a movement of the surface-to-be-scanned in a sub scanning direction, the light beams emitted from the plurality of luminous elements of this luminous element group are imaged on the surface-to-be-scanned at mutually different positions in the main scanning direction, and accordingly a plurality of spots are formed side by side in the main scanning direction, thereby forming a spot group, and
the following inequality is satisfied:
L·m>P−m·dp
where the symbol P denotes a distance between optical axes of the imaging lenses adjacent to each other in the longitudinal direction and the symbol L denotes an inter-element distance in the longitudinal direction between two luminous elements which are farthest from each other in each luminous element group.

2. The line head of claim 1, wherein
a first imaging lens and a second imaging lens are arranged adjacent to each other,
a first luminous element group is disposed corresponding to the first imaging lens,
a second luminous element group is disposed corresponding to the second imaging lens,
a first spot group is formed by the first luminous element group,
a second spot group is formed by the second luminous element group, and
the plurality of luminous elements are arranged and timings of emitting light beams from the plurality of luminous elements are adjusted such that the first spot group and the second spot group partly overlap with each other to form an overlapping spot region.

3. The line head of claim 2, wherein a diameter of the luminous elements which form overlapping spots belonging to the overlapping spot region among the plurality of luminous elements is smaller than a diameter of the remaining luminous elements.

4. The line head of claim 2, wherein an emitted light quantity of the luminous elements which form overlapping spots belonging to the overlapping spot region among the plurality of luminous elements is smaller than an emitted light quantity of the remaining luminous elements.

5. The line head of claim 2, wherein
a third imaging lens is arranged adjacent to the second imaging lens on an opposite side to the first imaging lens,
a third luminous element group is disposed corresponding to the third imaging lens,
a third spot group is formed by the third luminous element group, and
the plurality of luminous elements are arranged and timings of emitting light beams from the plurality of luminous elements are adjusted such that, of the spots belonging to the second spot group, all spots except for those belonging to the overlapping spot region overlap the third spot group.

6. The line head of claim 1, wherein
a plurality of luminous element lines each comprised of a plurality of luminous elements aligned in the longitudinal direction are so arranged in a width direction which is approximately orthogonal to the longitudinal direction in each of the plurality of luminous element groups as to arrange the luminous elements constituting each luminous element group in a staggered manner, and
the plurality of luminous elements constituting the luminous element line are turned on to emit light beams at timings corresponding to a movement of the surface-to-be-scanned in the sub scanning direction in each of the plurality of luminous element lines.

7. The line head of claim 1, wherein a plurality of lens lines each comprised of the plurality of imaging lenses aligned in the longitudinal direction are arranged in a width direction which is approximately orthogonal to the longitudinal direction to arrange the plurality of lenses constituting the lens array in a staggered manner.

8. An image forming apparatus, comprising:
a latent image carrier whose surface is transported in a sub scanning direction;
a line head which images a plurality of spots on a surface of the latent image carrier in a main scanning direction which is approximately orthogonal to the sub scanning direction to form a latent image; and
a developer which develops the latent image on the latent image carrier with toner, wherein
the line head comprises:
a lens array in which a plurality of imaging lenses whose absolute value of magnification is m are arranged in a longitudinal direction which corresponds to the main scanning direction; and
a plurality of luminous element groups which are disposed in one-to-one correspondence to the plurality of imaging lenses, wherein
in each one of the plurality of luminous element groups, the plurality of luminous elements are arranged at mutually different positions in the longitudinal direction spaced apart by an element pitch dp, the plurality of luminous elements of this luminous element group are respectively turned on to emit light beams at timings in conformity with a movement of the surface of the latent image carrier in the sub scanning direction, the light beams emitted from the plurality of luminous elements of this luminous element group are imaged on the surface of the latent image carrier at mutually different positions in the main scanning direction, and accordingly a plurality of spots are formed side by side in the main scanning direction, thereby forming a spot group, and the following inequality is satisfied:
L·m>P−m·dp
where the symbol P denotes a distance between optical axes of the imaging lenses adjacent to each other in the longitudinal direction and the symbol L denotes an inter-element distance in the longitudinal direction between two luminous elements which are farthest from each other in each luminous element group.
